(19) United States
(12) Patent Application Publication
(10) Pub. No.: US 2020/0232239 A1
(43) Pub. Date: Jul. 23, 2020

(54) Modular concrete storage structure

(71) Applicant: Marvin Reiff, Greenwood, WI (US)

(72) Inventor: Marvin Reiff, Greenwood, WI (US)

(21) Appl. No.: 16/842,517

(22) Filed: Apr. 7, 2020

Related U.S. Application Data
(63) Continuation-in-part of application No. 16/249,445, filed on Jan. 16, 2019.

(51) Int. Cl. E04H 7/28; E04B 7/20; E04B 1/04; A01F 25/16

(52) U.S. Cl. CPC E04H 7/28; E04B 7/20; E04B 2103/02; A01F 25/163; E04B 1/043

(57) ABSTRACT

A series of pre-fabricated building components assembled into modular units and further assembled into circular storage structures of various heights.

### CROSS-REFERENCE TO RELATED APPLICATIONS

This application is a continuation-in-part claiming priority to application Ser. No. 16/249,445 filed on Jan. 16, 2019, which is deemed incorporated by reference in its entirety in this application.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### REFERENCE TO A “SEQUENCE LISTING,” A TABLE, OR A COMPUTER PROGRAM LISTING APPENDIX SUBMITTED ON COMPACT DISC AND AN INCORPORATION-BY-REFERENCE OF THE MATERIAL ON THE COMPACT DISC

Not Applicable

### STATEMENT REGARDING PRIOR DISCLOSURES BY AN INVENTOR OR JOINT INVENTOR

Not Applicable

### BACKGROUND OF THE INVENTION

The present invention relates to storage structures and, more particularly, to storage structures made from pre-cast or pre-stressed concrete components.

Since ancient times, various storage structures have been employed. For example, for decades, if not centuries, silos have been used for the storage of corn and other grains. Silos have also been used to store silage, manure intended to be used as fertilizer, and other agricultural products. For at least the last one hundred years, there has been an increased demand for a low-cost durable silo structure. Various manufacturing methods have been employed for making silos, but these methods have not resulted in any substantial reduction in the cost of materials, labor to complete construction of the silo or in any significant advantages with respect to ease of construction. To this day, there continues to be a need for silos that are sufficiently strong to withstand the elements, inexpensive to manufacture, less laborious to manufacture, quicker to assemble on site, primarily assembled at ground level, and simple to build, move, disassemble and rebuild when desired.

Ideally, most of the components of the silo should be built in a controlled environment such as a factory to maintain better working conditions, better quality control and more consistent production to specifications. Likewise, the components should be adapted to be assembled using a crane to eliminate manual handling of components at considerable heights. Ideally, the number of components that must be assembled at the assembly site should be limited in number and in type to simplify assembly and the time required to complete the assembly.

### DESCRIPTION OF RELATED ART INCLUDING INFORMATION DISCLOSED UNDER 37 CFR 1.97 AND 37 CFR 1.98

Not Applicable

### BRIEF SUMMARY OF THE INVENTION

The invention comprises a series of pre-cast concrete wall panels configured to be attached to each other forming a hollow circular segment of a storage structure. Edges (top, bottom, and side) of the panels are configured with tongue and groove features to help align and interlock panels with adjacent panels. The outer surface is configured with features to secure one or more hoops passing around the outer circumference of the circular segment. Each circular segment is modular and movable once assembled. A series of circular segments are stacked one on other, preferably using a crane, forming the wall of a concrete storage structure. Seams in adjacent circular segments are preferably offset for additional strength. Adhesive is preferably applied to the tongue and/or groove features before they are assembled to provide additional strength and sealing.

The invention further comprises a series of pre-cast concrete panels configured to be attached to each other forming a round convex storage structure roof. Edges of the panels are configured with tongue and groove features to help align and interlock panels with adjacent panels. The round storage structure roof is modular and movable once assembled.

### BRIEF DESCRIPTION OF THE SEVERAL VIEWS OF THE DRAWING

The foregoing features, objects and advantages of the invention will become apparent to those skilled in the art from the following detailed description of the preferred embodiment, especially when considered in conjunction with the accompanying drawings in which like numerals in the several views refer to corresponding parts.

FIG. 1 is a plan view of a multi-layered storage structure made in accordance with the present invention.

FIG. 2 is a top view of a semi-circular concrete wall panel used in the construction of the circular layers of FIG. 1.

FIG. 3 is a cross-sectional view through line 3-3 in FIG. 2.

FIG. 4 is a bottom view of a circular layer made from semi-circular panels of the type shown in FIGS. 2 and 3.

FIG. 5 is a plan view of a multi-layered storage structure made in accordance with the present invention showing the location of locking assemblies used to lock various concrete components together.

FIG. 6 shows an assembly of horizontal and vertical lengths of rebar and locking members welded to the rebar embedded in the concrete panels of FIGS. 2-3.

FIG. 7 is a cross-sectional view illustrating a locking assembly locking a tongue and groove joint between two semi-circular concrete wall panels of the type shown in FIGS. 2 and 3.

FIG. 8 is a plan view of a hole through one of the bridging plates of one of the lock assemblies.

FIGS. 9 and 10 are cross-sectional views showing how a bolt passing through the hole of FIG. 8 is used to couple the bridging plate to a locking member embedded in the concrete of one of the concrete panels of the present invention.

FIG. 11 is a plan view of the concrete roof panels made in accordance with the present invention.

FIG. 12 is a cross-sectional view through line 12-12 in FIG. 11.

FIG. 13 is a cross-sectional view through line 13-13 in FIG. 11.

FIG. 14 is a cross-sectional view through line 14-14 in FIG. 10.

FIG. 15 is a top plan view of a roof of a storage structure made in accordance with the present invention showing the arrangement of the lock assemblies used to lock the tongue and groove joints between the panels of FIG. 10 together.

FIG. 16 is a side plan view of the roof of FIG. 11 after the panels have been assembled showing the arrangement of the lock assemblies used to lock the tongue and groove joints between the panels of the roof of FIG. 11 with the top circular layer comprising the semi-circular concrete wall panels illustrated in FIG. 5.

FIG. 17 is a perspective view showing a partially assembled stack of modified panels with several left out of the stack so that both the inside and outside of the stack are visible.

FIG. 18 is a partial perspective view of the stack shown in FIG. 17 illustrating the tongue and groove joints employed to assemble the stack of modified panels shown in FIG. 17.

FIG. 19 is a perspective view of a roof segment of the present invention.

FIG. 20 is an exterior perspective view of a roof portion comprised of roof segments of the present invention.

FIG. 21 is an exploded exterior perspective view of a roof of the present invention.

FIG. 22 is an interior perspective view of a roof portion comprised of roof segments of the present invention.

FIG. 23 is a perspective view of an assembled storage structure of the present invention secured by vertical and horizontal bands.

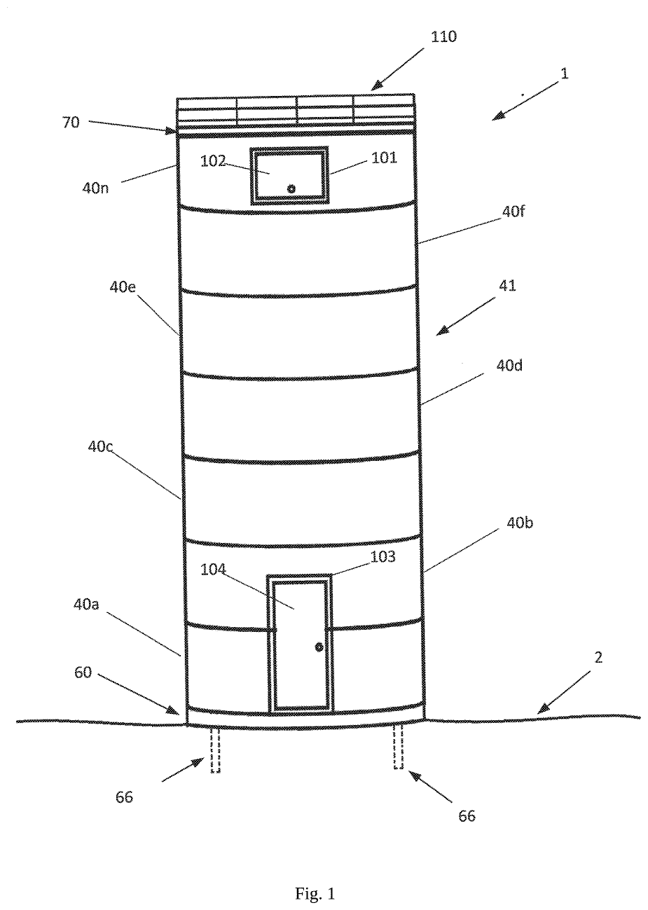

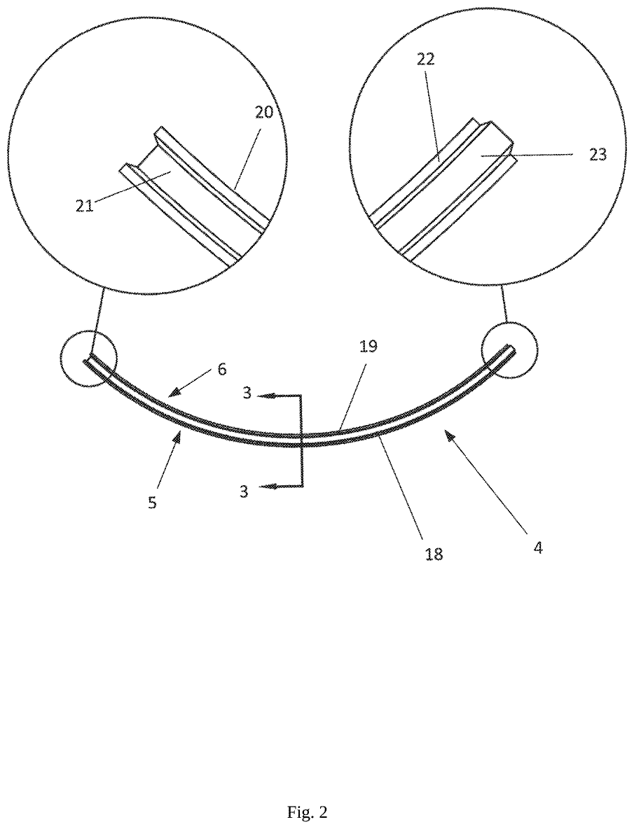

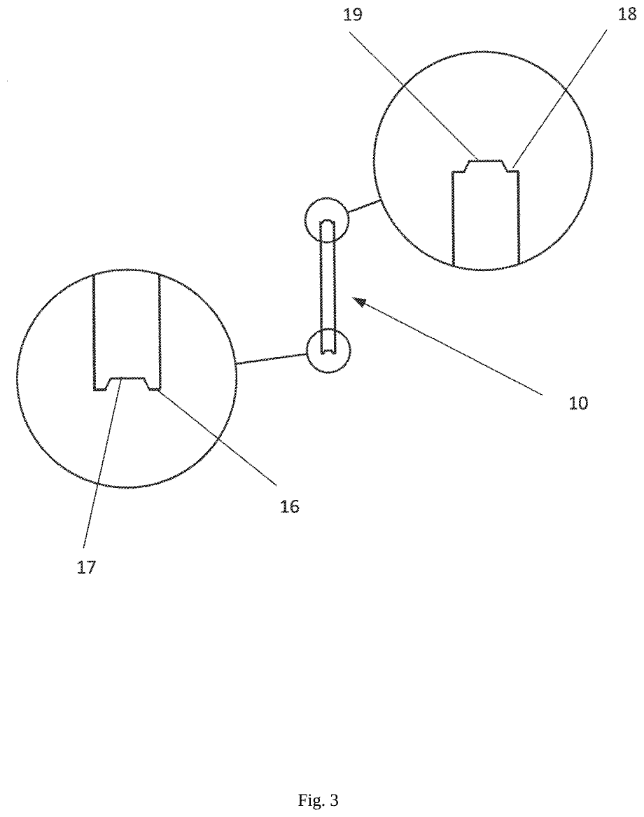

### DETAILED DESCRIPTION OF THE INVENTION

This description of the preferred embodiments is intended to be read in connection with the accompanying drawings, which are to be considered part of the entire written description of this invention. In the description, relative terms such as “lower”, “upper”, “horizontal”, “vertical”, “above”, “below”, “up”, “down”, “top” and “bottom” as well as derivatives thereof (e.g., “horizontally”, “downwardly”, “upwardly”, etc.) should be construed to refer to the orientation as then described or as shown in the drawings under discussion. These relative terms are for convenience of description and do not require that the apparatus be constructed or operated in a particular orientation. Terms such as “connected”, “connecting”, “attached”, “attaching”, “join” and “joining” are used interchangeably and refer to one structure or surface being secured to another structure or surface or integrally fabricated in one piece, unless expressively described otherwise. Further, for the purposes of this application, including claims, where not otherwise indicated, plurality means at least one.

The storage structure 1 of the present invention is a generally cylindrical structure. Component pieces of the structure are preferably made off-site, transported to the installation location, and assembled. The component pieces are preferably made of pre-cast/pre-stressed concrete. The component pieces may contain re-bar, wire mesh, fiberglass strands, or other strengthening materials. When strengthening components containing metals are contained in the component pieces, the strengthening components are preferably encapsulated in the concrete to reduce corrosion.

The walls of the storage structure 1 are preferably generally cylindrical. Component wall pieces 4 therefore preferably have interior faces 19 which form the arc of a circle. When a plurality of component wall pieces 4 are connected end-to-end, they form the wall section of a cylinder 40, having an open top and bottom. This wall section of a cylinder 40 may be called a course. The top, bottom, left, and right edges of the component pieces are preferably configured with cooperating tongue and groove features. For example, if the top of a component wall piece is configured with tongue features 19, the bottom is preferably configured with groove features 17 so the tongue features 40 of one course 40 fit into groove features 17 of the next higher course 40. In a preferred embodiment, the top of component wall pieces 4 are configured with tongue features 19 and the bottom of component wall pieces 4 are configured with groove features 17, though top and bottom cooperating features may be reversed without deviating from the present invention. By way of further example, if the left edge of a component wall piece 4 is configured with tongue features 23, the right edge of a component wall piece 4 is configured with groove features 21 so the tongue features 23 of component wall piece fit 4 into groove features 21 of the adjacent wall component piece 4.

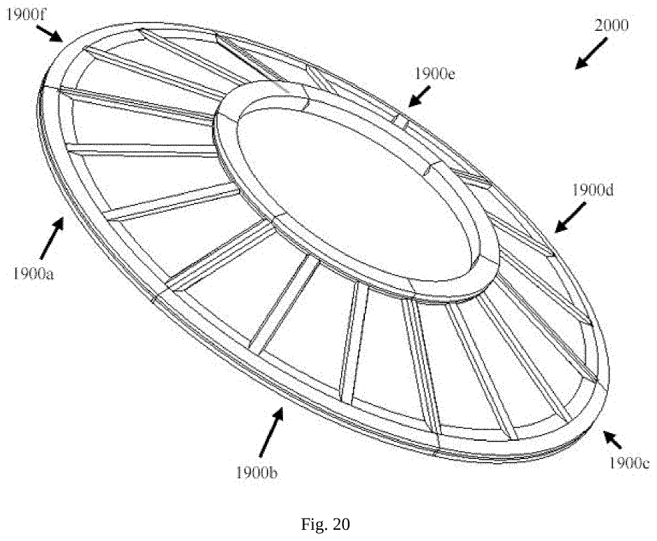

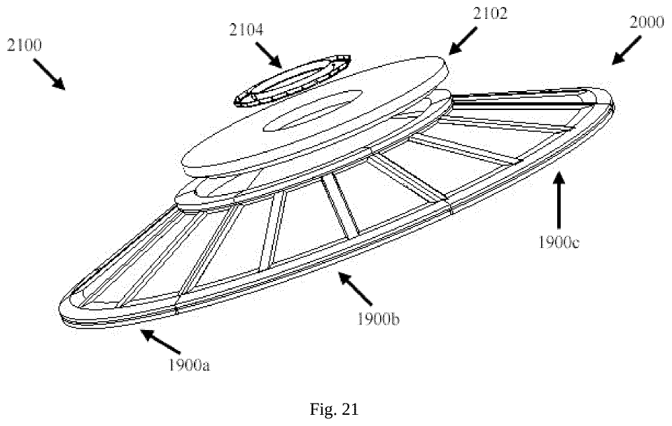

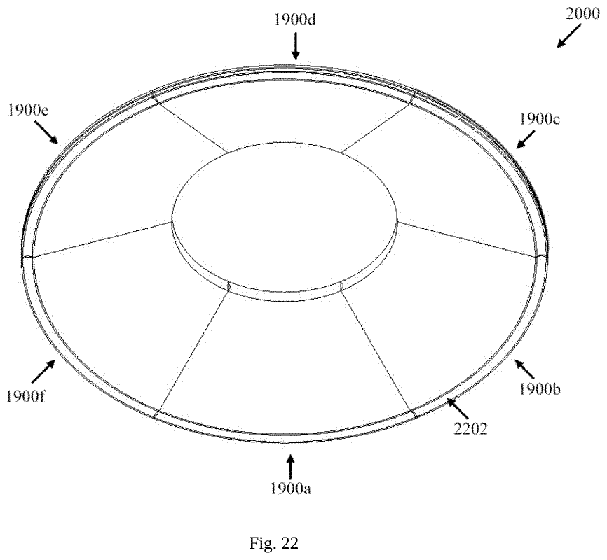

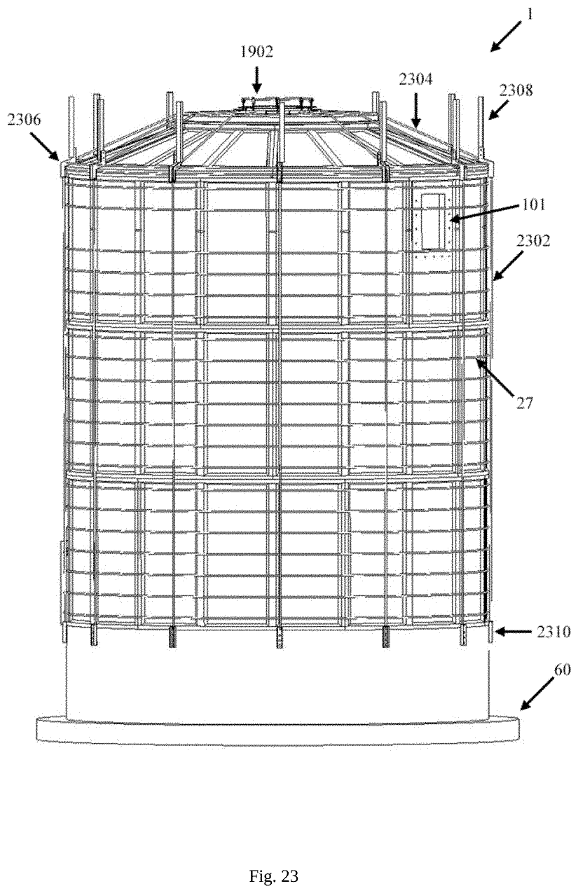

In a preferred embodiment, after or as the component wall pieces 4 are assembled into a course 40, the component wall pieces 4 of the course 40 may be further secured by a band 130. In a preferred embodiment, at least some component wall pieces 4 are therefore further configured with features 122 by which one or more bands 130 may cooperatively interact with the component wall pieces 4. The band(s) 130 of one course (e.g. 40d) are separate from, and not connected to, the band(s) 130 of adjacent courses (e.g. 40c and 40e) thereby making each course 40 a self-contained unit. In a preferred embodiment, each band 130 is attached to itself (see FIGS. 20 and 21). In an alternative embodiment, the ends of each band are attached to a feature on a component wall piece.

The number of bands 130 on a course 40 may vary based on the location of the course 40 in the storage structure 1. For example, a bottom course 40 in a storage structure 1 may have 7 bands 130. A course 40 mid-way up the storage structure 1 may have 4 bands. A course 40 near the top of the storage structure 1 may have 1 band 130.

The component wall pieces 4 are preferably configured having a thickness which is less at the center and greater at the edges. The thickness of the component wall pieces 4 at the center is selected to provide the desired amount of crush resistance and resistance to outward forces when the storage structure 1 is filled. The edges of the component wall pieces 4 is preferably selected such that the tongue and groove features have sufficient height, depth, and thickness to aid in alignment when component wall pieces 4 are assembled, sufficient surface area for adhesive to adhere, and resist sheering between adjacent component wall pieces 4. The dimensions of the tongue and groove features may also be selected to achieve the desired of fit between component wall pieces 4 when a seal is placed between component wall pieces 4.

The roof 70 of the storage structure 1 is preferably comprised, at least in part, of pre-cast/pre-stressed concrete panels. The bottom edges 78 of roof panels 71, 72, 73 are preferably configured to rest on the top of the top course 40 of wall panels and are preferably configured with features configured to interact with features on top of the top course 40 of wall panels. In a preferred embodiment, the bottom edges 78 of the roof panels 71, 72, 73 are configured with grooves 79 configured to interact with tongue features 19 of the top course. In a preferred embodiment, internal edges 74, 76, 80, 82 of roof panels are configured with cooperative tongue 75, 77 and groove 81, 83 features. In a preferred embodiment, some component roof panels have the shape of a truncated sector. At least one component roof panel then is then preferably circular configured to close the opening left by the truncated section of other component roof panels.

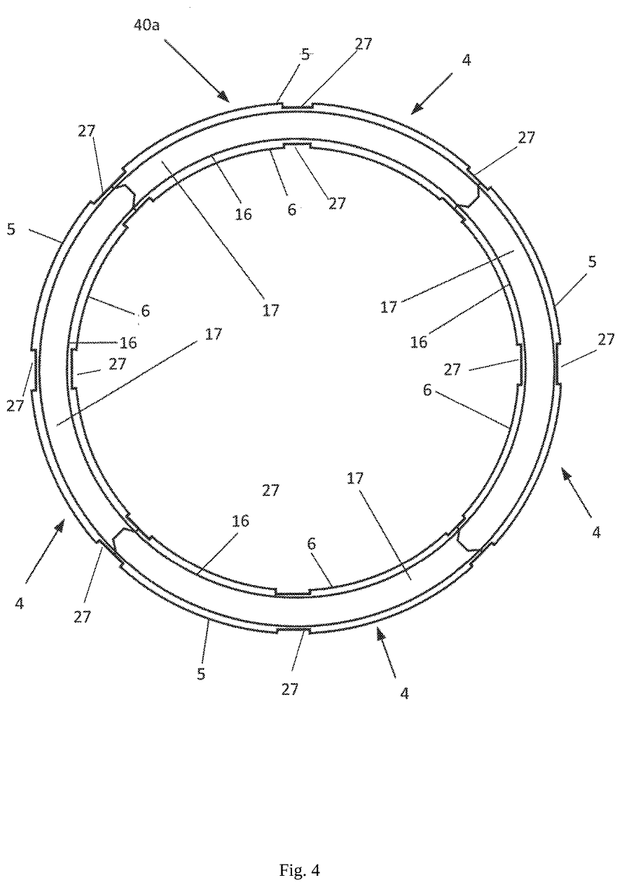

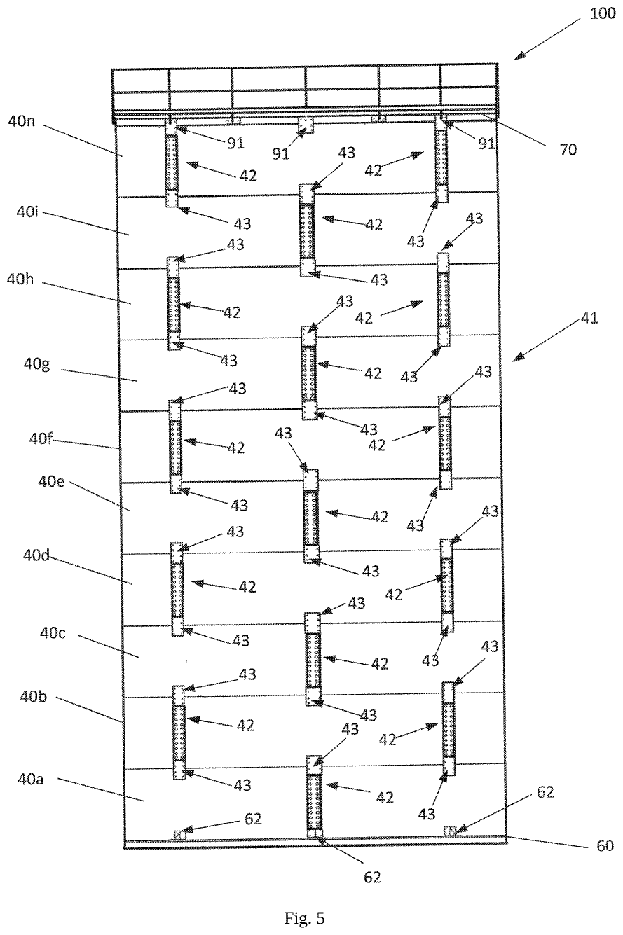

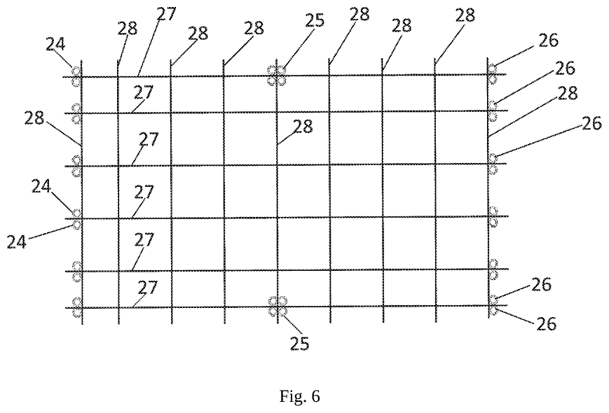

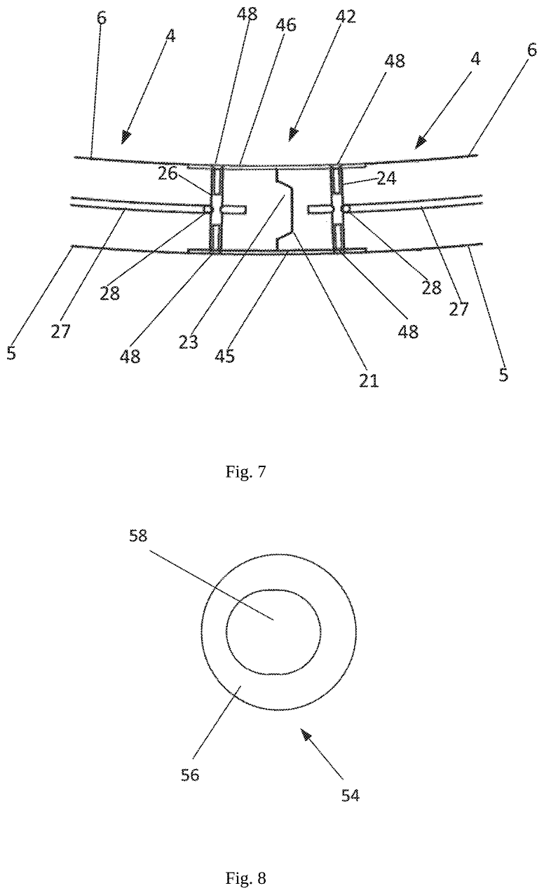

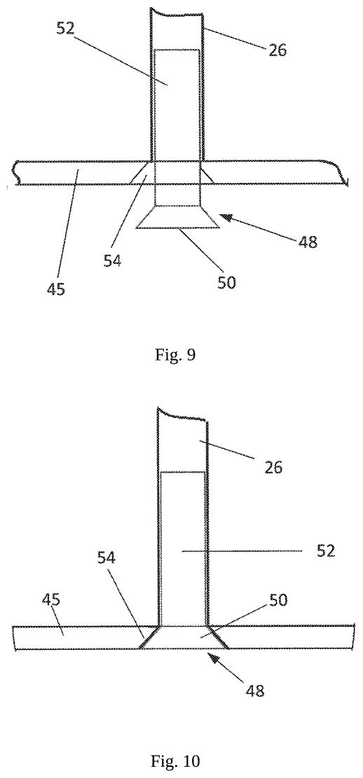

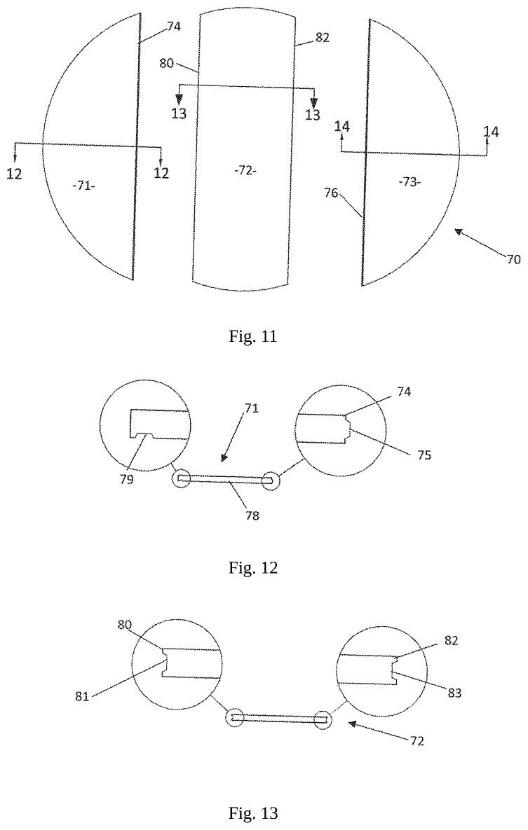

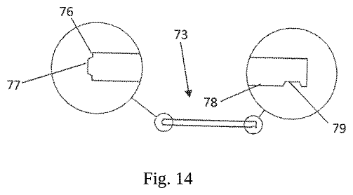

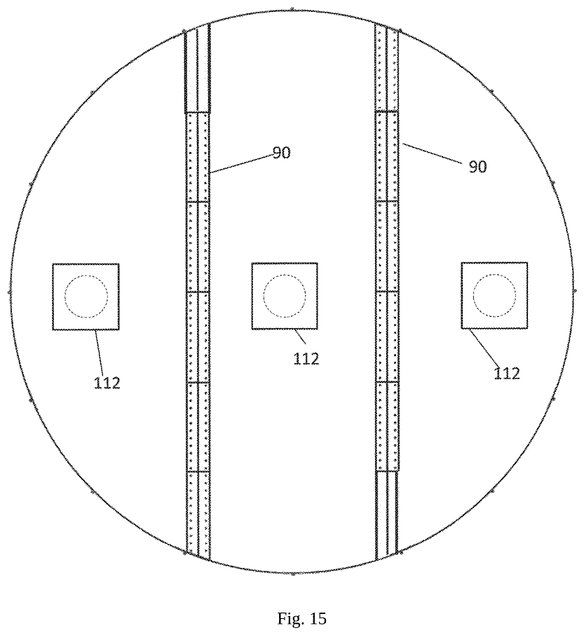

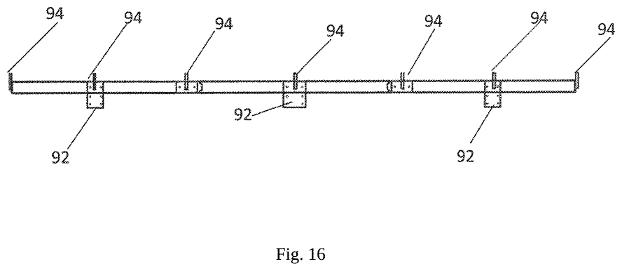

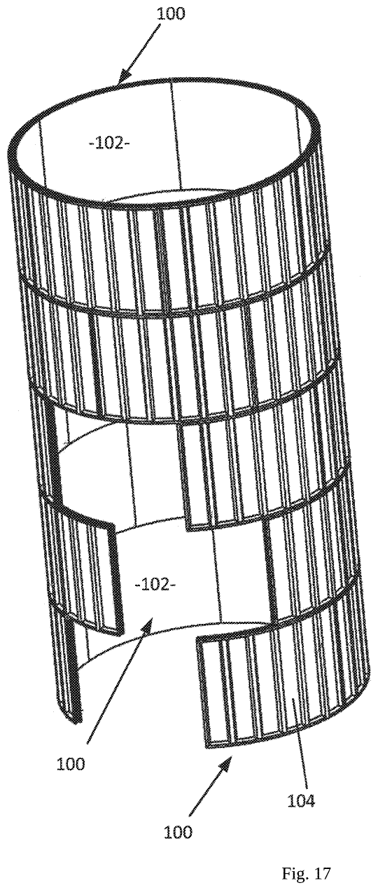

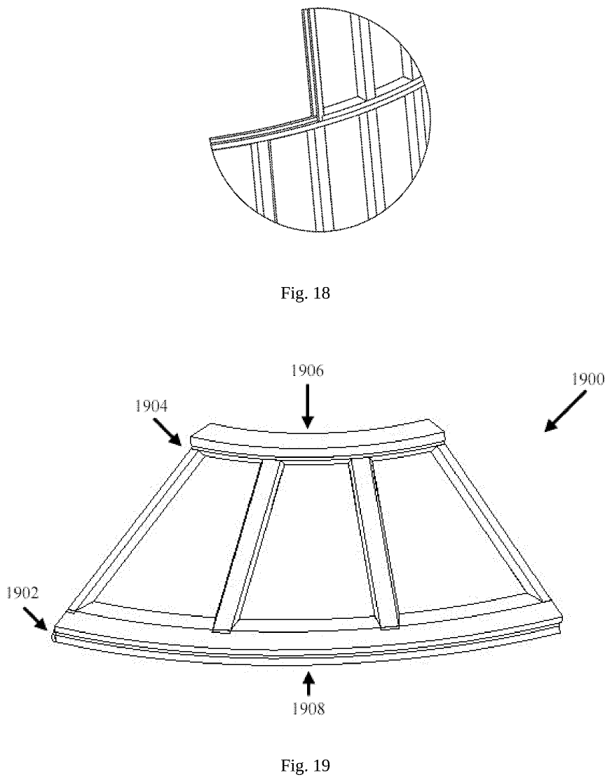

Component wall and ceiling pieces 4 are preferably manufactured at a facility where the quality can be strictly controlled and the concrete can be tested. Component wall pieces are then shipped to the location where the storage structure 1 is to be constructed. The storage structure 1 of the present invention is built by placing a pad 60 at the location 2 where the storage structure 1 is desired. In an alternative embodiment, a structure, such as a drive-through loading/unloading structure, or other receptacle for the In a preferred embodiment, features configured to interact with features of the bottom course 40 are preferably formed into, or attached to, the pad. Appropriate anchors or foundations 60 may be installed on/under the pad. Component wall pieces 4 are assembled as course 40 (see FIG. 4). If desired, adhesive and/or seals are placed between adjacent component wall pieces 4 as they are assembled to provide the desired strength and/or sealing properties. One or more bands 130 are placed around the course 40. The process is then repeated for subsequent courses. Each course 40 is preferably assembled at or near ground level before courses 40 are stacked one on another. Similarly, the component pieces of the roof panels are preferably assembled to form the roof.

Once the desired number of courses 40 (selected based upon the desired height) of the storage structure 1) and roof 70 are assembled, further assembly of the storage structure 1 is ready to commence. A crane is preferably brought to the site. Any necessary adhesive or seal is placed on the pad 60 where the bottom course 40a will be placed. Any necessary adhesive or seal is placed on the top of the course 40a before it is placed. The crane is then used to lift the course 40a and place the course 40a on the pad 60. Any necessary adhesive or seal is placed on the top of subsequent courses 40b, 40c, 40d, etc. before it is placed to maximize safety by performing as much work as possible close to the ground. A man-lift, ladder, or other means may be used to elevate workers to the level necessary to align courses as they are stacked. Once all desired courses 40 are stacked forming the wall of the storage structures 1, the roof 70 is placed on top of the top course 40. If desired, a coating may be applied to the interior of the walls and/or roof 70 to provide desired characteristics including, but not limited to, lubricity, permeability, et. al. characteristics. In this manner, a relatively large storage structure 1 may be installed in a relatively short time.

At a later date, the capacity of the storage structure 1 may be increased by removing the roof 70, performing any necessary cleaning of the top of the top course 40, adding additional courses 40, and placing the same or a different roof 70 on top of the now top course 40. Additionally, bands 130 may be added to courses 40 as appropriate to support additional stresses from the addition of new courses 40. At a later date, if there is a desire for the storage structure 1 to no longer be placed at the site (wither to move the storage structure 1 to a new site, or demolish the structure), component pieces (roof 70, and courses 40) may be removed, top-to-bottom. The roof 70 may be disassembled into its component pieces (71, 72, 73), and courses 40 may be disassembled into their component pieces 4. so the component pieces may be relocated at minimal cost. This modularity maximizes the value of a storage structure 1 by reducing demolition costs and providing additional markets for storage structures 1.

In an alternative embodiment, the roof of the storage structure 2100 comprises a series of roof segments 1900 each of which is generally the shape of a truncated sector. The roof segments are preferably configured with a plurality of band attachment features. In a preferred embodiment, the band attachment features comprise a groove 1902 around the exterior 1908 of the roof segment 1900 and a groove 1904 near the interior 1906 of the roof segment 1900. In certain embodiments, the series of roof segments 1900 may be configured with additional features for additional band(s). In a preferred embodiment, the roof segments 1900 are configured with tongue and groove features on the sides where they are configured to mate with adjacent roof segments. When placed side-to-side, the roof segments 1900a-f form a disc with an open center 2000. In a preferred embodiment, the bottom of the disc 2000 is concave. In a preferred embodiment, the bottom of the roof segments 1900 are configured with tongue and/or groove 2202 features where the roof 2100 is configured to rest on the top course 40. The roof further comprises an outer cap 2102. The outer cap 2102 is preferably the shape of a circular disc with an open center. The outer edge of the outer cap 2102 is configured to mate with the interior 1906 of the open center of the disc 2000 formed by the roof segments 1900a-f. The roof further comprises an inner cap 2104. The outer edge of the inner cap 2104 is configured to mate with the interior of the open center of the outer cap 2102.

In a preferred embodiment, the roof 2100 is secured to the storage structure 1. A plurality of roof brackets 2306 are preferably attached to the edge of the roof 2100. A plurality of base brackets 2310 are preferably attached to or adjacent the base 60. A plurality of bands 2304 are attached to the inner cap 2104. The bands preferably pass over the brackets 2306 and are attached to the brackets 2310 adjacent the base 60. In an alternative embodiment, a band 2304 passes from inner cap 2104 to a roof bracket 2306 and a separate band 2302 passes from the roof bracket 2308 to a base bracket 2310. The bands 2302 and 2304 are then tightened to a desired tension.

In a preferred embodiment, the roof 2100 is assembled by preparing the sides of a roof segment 1900a (e.g. by applying adhesive), placing another roof segment 1900b adjacent the first roof segment 1900a, and repeating the process until a disc 2000 is created. One or more bands are then placed around the disc 2000 in the band attachment features (1902, 1904) to hold the disc 2000 together. The top course 40 is then prepared as necessary, the disc 2000 is then lifted, preferably with a crane, and placed on the top course so tongue and groove features on the top course 40 mate with tongue and groove features in the bottom of the disc. The outer ring 2102 is then placed in the opening of the disc 2000. The inner ring 2104 is then placed in the opening of the outer ring 2102.

For purposes of this application, including disclosure and claims, tongue and groove features include any of a variety of radii greater than or equal to zero, including ball-and-socket joining features.

1. A storage structure comprising:
A) two or more cylindrical sections having an open bottom and top comprising:
i) a two or more pre-formed wall segments having:
a) tongue or groove features on each edge configured to interface with tongue or groove features of adjacent segments,
b) a thickness greater at the edges than at the center, and
c) features configured to support a plurality of bands encircling said two or more pre-formed segments, and
ii) a plurality of bands substantially encircling said pre-formed wall segments of said cylindrical section:
a) wherein said plurality of bands are not connected to a plurality of bands which encircle an adjacent section.

2. The storage structure of claim 1 wherein:
A) said two or more pre-formed wall segments have a horizontal cross section having a face forming the interior of said section defines the arc of a circle.

3. The storage structure of claim 1 wherein said two or more pre-formed wall segments further comprise:
A) a liner applied to the interior of said pre-formed wall segments during the manufacturing process.

4. The storage structure of claim 1 further comprising:
A) a plurality of openings in cylindrical sections are defined by two-piece opening frame members.

5. The storage structure of claim 4 wherein:
A) said plurality of openings in cylindrical sections are covered by a plurality of movable door members.

6. The storage structure of claim 4 wherein:
A) said plurality of bands are connected to opening frame members.

7. The storage structure of claim 1 wherein:
A) said plurality of bands substantially encircling said pre-formed wall segments of said cylindrical section is connected to itself substantially end-to-end.

8. The storage structure of claim 7 wherein:
A) none of said plurality of bands encircling said pre-formed wall segments of said cylindrical section is connected to another adjacent band encircling said pre-formed wall segments of said cylindrical section.

9. The storage structure of claim 8 wherein seams between two or more pre-formed wall segments in adjacent cylindrical sections are arranged to not align.

10. A storage structure roof comprising:
A) a plurality of pre-formed ceiling segments having:
i) the shape of a truncated sector,
ii) tongue or groove features on each edge configured to interface with tongue or groove features of an adjacent pre-formed ceiling segment, and
iii) tongue or groove features on each surface configured to interface with said pre-formed wall segments.

11. The storage structure roof of claim 10 wherein said plurality of pre-formed ceiling segments further comprise:
A) a plurality of band attachment points configured to accept a band passing around a portion of said storage structure roof.

12. The storage structure roof of claim 11 further comprising:
A) an outer cap member configured to at least partially enclose an opening defined by the truncated portion of the truncated sector shape of said plurality of pre-formed ceiling segments.

13. The storage structure roof of claim 12 further comprising:
A) an inner cap member configured to at least partially enclose an opening defined by an opening in said outer cap member wherein said inner cap wherein said inner cap comprises a plurality of attachment points configured for the attachment of a plurality of bands passing from said storage structure roof to a location below the top of said storage structure roof.

14. The storage structure of claim 13 further comprising:
A) a plurality of bands connected to said plurality of attachment points and to receiving points.

15. A method for assembling a storage structure comprising:
A) placing said a plurality of pre-formed wall segments side-to-side having:
i) a horizontal cross section where the face forming the interior of the section defines the arc of a circle,
ii) tongue or groove features on each edge configured to interface with tongue or groove features of adjacent segments,
iii) a thickness greater at the edges than at the center, and
iv) features configured to support a plurality of bands encircling said plurality of pre-formed segments,
B) attaching said plurality of pre-formed wall segments to form a cylindrical wall section, and
C) attaching a plurality of bands around said cylindrical wall section.

16. The method of claim 15 further comprising:
A) applying a sealing substance to the sides of said plurality of pre-formed wall segments prior to placing them side-to-side.

17. The method of claim 15 further comprising:
A) stacking a plurality of cylindrical wall sections to form the wall(s) of a storage structure.

18. The method of claim 17 further comprising:
A) rotationally arranging adjacent cylindrical sections such that intersections between said two or more pre-formed wall segments in said adjacent cylindrical sections do not align.

19. The method of claim 17 further comprising:
A) applying a sealing substance to a top or bottom of a cylindrical wall section prior to stacking said plurality of cylindrical wall sections.
